(19) United States
(12) Patent Application Publication
(10) Pub. No.: US 2020/0042291 A1
(43) Pub. Date: Feb. 6, 2020

(54) Software System Generating System

(71) Applicant: Arcare lnnova Corp., Taipei City 104 (TW)

(72) Inventor: Yi Chang Sung, Taipei City (TW)

(21) Appl. No.: 16/215,729

(22) Filed: Dec. 11, 2018

Related U.S. Application Data
(63) Continuation of application No. 16/052,722, filed on Aug. 2, 2018.

(51) Int. Cl. G06F 8/30

(52) U.S. Cl. CPC G06F 8/30

(57) ABSTRACT

A software system generating system comprises a specification generating module and a software system generating module wherein the software system generating module outputs a structured specification according to information being provided by user's demand; the software system generating module includes a plurality of predefined elements which each element is a programmable unit; the structured specification defines characteristics of the element to generate forms which the characteristic is a combination relationship of the plurality of predefined elements; after inputting the structured specification into the software system generating module and processing through a coding process, the software system generating module generates a system menu and its relevant links based on the analyzed system architecture to form a complete processing procedure; and the software system generating module complies and interprets the system program code combination to generate the result system.

### FIELD OF THE INVENTION

The present invention relates to a software system generating system, and more particularly to a generating system for generating structured specifications by analyzing and creating user's demands.

### BACKGROUND OF THE INVENTION

Software (program) products are now an indispensable part of social life. The main reason why most of the types of electronic products can be operated is because of the software programs integrated in those products; the products are driven by those integrated programs in order to be operated or controlled automatically. The current programming process usually requires a system analyst to understand the demands of the client first, in which the system analyst will produce a system functional specification specifying the client's demands, and provide this system functional specification to a system designer for formulating detailed designs in a written specification. The written specification will then be provided to all members of the program development team to understand the details of the design for building the software program and convert it into a specific programming language.

Current software design specifications are mainly presented using conventional document editors or in conjunction with flowchart editors in a form of literal descriptions and flowcharts. These charts and literal descriptions are to be provided to and studied by the downstream programmers. However, even if the software design specifications provided to the programmers are presented as detailed as it could be, problems such as lack of completeness or misinterpretations of the information given to the programming team members may still occur. Moreover, because literal information might be delivered wrongly or being interpreted in different ways, it may result in numerous time-consuming back-and-forth redundant communications and confirmations among the demand offering (the client) side, the system analyzing side (the system analyzer), and the programming side (the programmer), which may cause delays in the development time and reduction in system development productivity as a consequence.

### SUMMARY OF THE INVENTION

In order to solve technical problems of software program design, such as prolonging development time that causes cost increment due to misunderstandings derived from conventional program development work flows, namely from developing specific requirements to the completion of the final program design, a structured detail-design specification file that can be used as an input to an automatic software program generating module is provided by the present invention, so that an executable system can be generated after determining the specification at the beginning of the entire development process, thereby avoiding back-and-forth communications that are time consuming which cause delay of the entire development.

Therefore, a software system generating system is provided. The software system generating system comprises a specification generating module and a software system generating module wherein the software system generating module outputs a structured specification according to information being provided by user's demand; the software system generating module includes a plurality of predefined elements which each element is a programmable unit; the structured specification defines characteristics of the element to generate forms which the characteristic is a combination relationship of the plurality of predefined elements; after inputting the structured specification into the software system generating module and processing through a coding process, the software system generating module generates a system menu and its relevant links based on the analyzed system architecture to form a complete processing procedure; and the software system generating module complies and interprets the system program code combination to generate the result system.

In summary, numerous advantages can be achieved by the aforementioned method of the present invention:

1. All communications between the clients making requirements and the program designers are completed during setting and generating the structured specification, therefore, after confirming the structured specification, it would be confirmed that the results output from system execution meets the requirements as specified in the structured specification. If the executed result of the program to be developed does not meet the original requirements or encounters errors, it leads to the structured specification rather than the programming itself. Hence, the automatic software program generating system disclosed in the present invention may solve problems of missing information or misunderstandings majorly caused while generating programmer-understandable workflow and descriptions by the clients and the system analysts, and the back-and-forth communications among multiple teams of multiple programmers interpreting the workflow and descriptions to divide the programming works for building the corresponding program modules, which lead to significant prolongation of development time and cost increment of development.

2. After completion of the structured specification, the clients, users, may deliver the entire BOM to a program (software) factory for automatic processing, and obtain a final product that is the application system that should meet the structured specification of a specific project for the client's final inspection and confirmation. The programs implemented in the so-called program factory is adapted to read the BOM content of the specific project, correctly and entirely interpreting the programming details of programmers in order to automatically generate an executable system application according to the BOM content without involving any man programmers, thereby saving a lot of manpower resources and time and controlling the due date and the quality of their product produced.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a schematic block diagram illustrating an automatic software program generating system;

FIG. 2 is a schematic diagram illustrating a specification generating module of the present invention;

FIG. 3 is a schematic diagram illustrating a demand input user interface of a specification generating module;

FIG. 4 is a schematic functional block diagram of the specification generating module; and

FIG. 5 is a schematic diagram illustrating the architecture of the automatic software program generating system from the BOM content of a specific project.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method or the system by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that when an element is referred to as being “connected” to another element, it can be directly connected to the other element or intervening elements may be present.

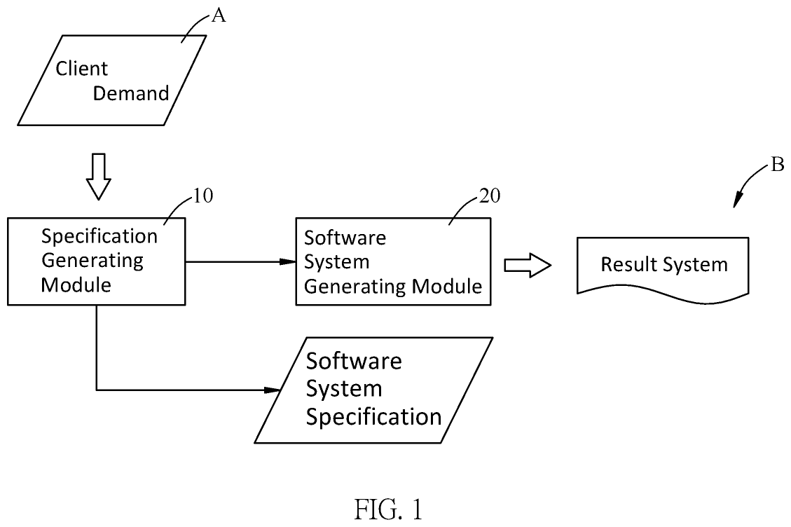

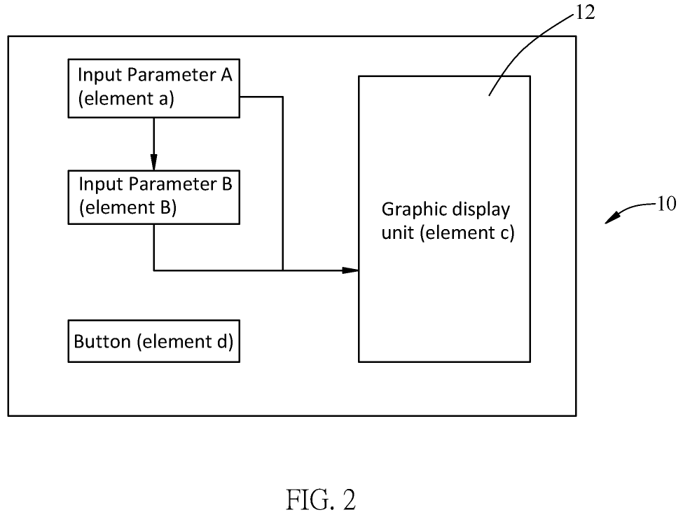

Referring to FIG. 1 and FIG. 2, which are schematic block diagrams illustrating a software system generating system of the present invention. The software system generating system includes a specification generating module 10 and a software system generating module 20. The specification generating module 10 outputs a structured specification according to information provided by client demand A. After inputting the structured specification into the software system generating module 20, and processing through specification importation, coding and decoding processes, an executable result system B can be outputted. The result system B is an executable program of unlimited types, including but not limited to invoicing, project management, human resources systems. The generating system may be a computer system with built in executable program or software system. The format of the structured specification can be XML (Extensible Markup Language), the database format (Database), etc.

The specification generating module 10 includes a plurality of predefined elements 12, each of the elements 12 are corresponded to a part number, the part numbers can be generated and assigned to the corresponding elements 12 at the time the structured specification has been generated, where each element 12 may be a programmable unit having different purposes and functions. The structured specification defines the characteristics of the selected or used elements 12, in which the characteristics include the followings:

(1) Function of the element 12: For example, the elements 12 provided by the specification generating module 10 may be an arithmetic logic, a functional object, and the like. The system designer can select a suitable combination of the elements 12 to generate a form, a database, or a user interface. The functional object may be a button, a graphic display unit, a drawing unit, etc.

(2) Value of the element 12: can be a text, a value, a range of values and so on.

(3) Attribute of the element 12: The different elements 12 may have more than one identical or different attributes, the attributes may vary upon different types of the elements 12, for example, if the element 12 belongs to a data type element, the attribute of the element 12 may be a name, a unit, a specification and so on. For instance, if the element 12 is a functional button, the attribute of that element 12 may be a name that defines the button, an input parameter, an output parameter, or an action type.

(4) Input/output of the element 12: There may be an input-output relationship between different elements 12 that are in different types, and an input-output interaction relationship among the elements 12 may be defined and generated based on the input and output of the elements 12. The so-called input-output interaction relationship may be a numerical input-and-output relationship, an algorithmic relationship, or a control relationship between the elements 12.

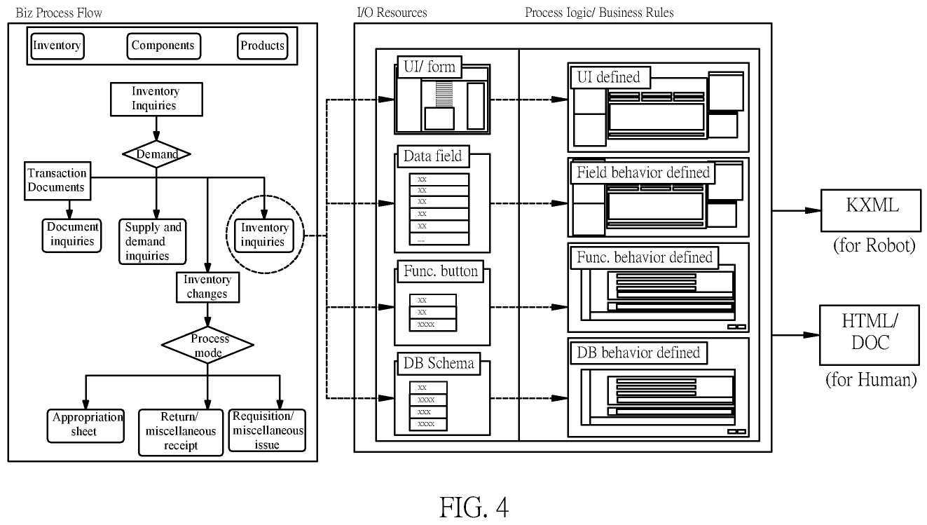

Referring to FIG. 1 to FIG. 4, illustrating an example of generating the structured specification according to the present invention, in which the client demand A is illustrated in a form of process structure, as shown in FIG. 4. While taking an invoicing system as an example of the client demand A, implementation of an inventory query function is a must. The process structure for practicing the function may include:

(STEP 1) Selecting demanded items;

(STEP 2) Providing options of document inquiries, supply and demand inquiries, parts inventory inquiries, inventory changes; and

(STEP 3) Providing further functions and procedures for each of the options in STEP 2 above, such as generating reports, menus or outputting results.

Upon the completion of the foregoing process flow, a system designer can decide the characteristics of the elements 12 in a declaration or definition manner (i.e., function, attribute, input-output interaction relationship), assemble and define all of the elements 12 defined by the structured specification, and generate definition of the relationship among the input, the intermediate process, and the output. Accordingly, when the structured specification has been correctly defined, problems such as lack of information integrity and misunderstandings while producing programs in conventional manners may be solved, unnecessary back-and-forth communications can be eliminated, thereby facilitating the development of programming.

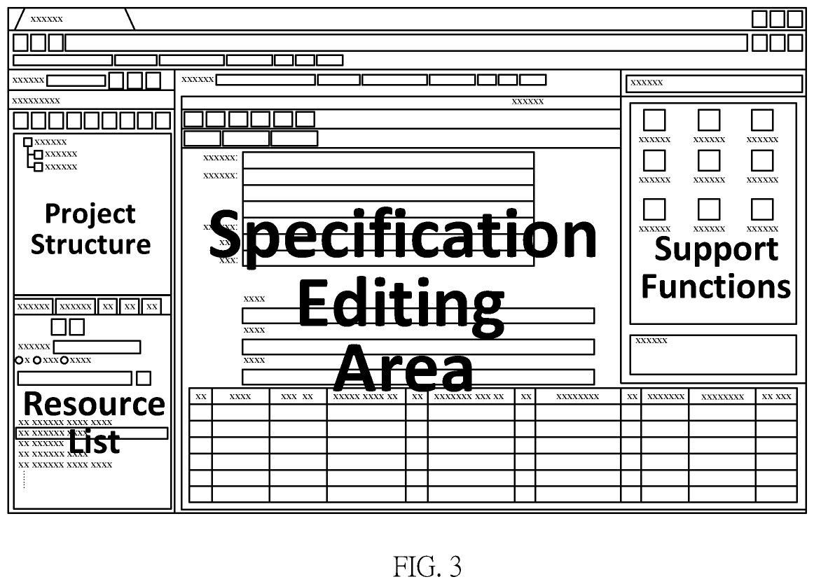

Please refer to FIG. 3, for generating the structured specification smoothly, a specification editing interface may be provided to the programmer in order to select and effectively edit relevant definition of the elements 12. The specification editing interface may provide a project structure, a resource list, and a specification editing area, where the project structure is used to define and declare the execution flow and the subordinate relationship structure. The resource list is to provide the elements 12 that are essential to each project; the specification editing area is to define the characteristics among the elements 12, and to assign the function, attribute, value, and/or the input-output interaction relationship of the elements 12.

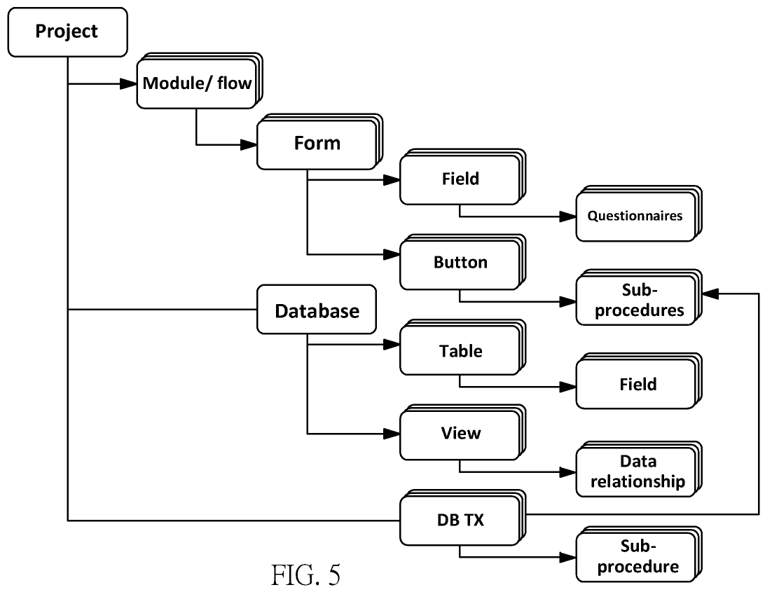

Please refer to FIGS. 4 and 5, while generating the structured specification, the specification generating module 10 can be based on the following steps:

S1) Declaring system architecture and execution flow: develop the required execution flow and system architecture according to the client demand A. The so-called execution flow is the process flow expected to be executed while the client executes the result system B. Taking a new parts feeding function of a inventory management system as a practical example, the work flow expected by the clients should be:

(STEP 1) Generate a new parts form;

(STEP 2) Select or type in the “Parts”, “Category”, “Specifications” and “Quantity” in the new parts form; and

(STEP 3) Click on a “Create” button to update a material library based on the selected “Parts”, “Category”, “Specifications” and “Quantity”.

Based on the foregoing (STEP 1) to (STEP 3), the present step S1 needs to complete the database structure, establishing the foregoing steps order and the elements 12 to be correspond to (the elements 12 of which the number can be set, the elements 12 of which the specification can be set, the element 12 of the “create” button . . . ).

S2) Form selection and setup: according to the foregoing inventory management system example, select the default format of the form or setup the format of the form, and select the appropriate elements 12 in the form. The form is a combination of the elements 12 selected.

S3) Declare database content: based on demand, setup the fields and formats needed in the database, which may include but not limited to a table, a view and an index.

S4) Define the function, value, attribute, and input-output interaction relationship of the elements 12: determine/declare or define the relationship among the elements 12; taking the inventory management system mentioned above as an example with referring to FIG. 2, assuming that there are 20 parts of “M4 screw” in stock, which is already below its safety stock level, thus 5000 additional parts are to be purchased and typed in the “new parts form”, a value of the element 12 (element a) in the new parts form representing the current stock status is shown as 20; a value of another element 12 (element b) representing the number of the newly purchased parts is filled-in with 5000. As a result, the input-output interaction relationship of the element 12 (element c), which represents the final stock status of the total parts after purchasing, and the element 12 (element a), which represents the current stock status, and the element 12 (element b), which represents the newly purchased number of parts may be defined as an addition equation of c=a+b. Additionally, users may further execute a botton (element d) to operate a calculation and displaying aforementioned values. Therefore, by defining each element 12, the elements 12 functioning the addition equation may be selected, and the logic relationship can be setup and declared.

S5) Format conversion: convert and save the info inputted by the programmer into structured format, completely preserve all types of programming info, processing specifications and their relationships.

The relationships among the elements 12 of a project and their functions, attributes, etc. are built in a BOM (bill of material) format in the specification generating module 10. In short, the structured specification generating process is to create all relationships of the elements 12 in the BOM. Therefore, by applying the concept of BOM, that is, to use the declaration and definition of the elements 12 to form the entire operation structure of the project step-by-step, the input resources (i.e., the aforementioned values and attributes, etc.), process rules (i.e. the aforementioned functions), and the destinations of the output items (i.e. the aforementioned input and output) to be inputted to the process nodes of the elements 12 can be formed by referencing the input-output interaction relationships among the elements 12. Based on this logistic, the time the BOM is created, the functions of the elements 12 to be executed, the communications and the subordinate relationships among the elements 12 can be generated, and when the structured specification is saved in the database, the corresponding part numbers of the elements 12 can be generated. In short, by implementing the technical features of the present embodiment, the system designer may, after understanding the client's demands, select the current elements 12, declare and define the characteristics of the elements 12, and compile the specifications and subordinate relationships of the elements 12 in the BOM format for assigning specific part numbers to each element 12 based on the demand. The manner of generating part numbers may include using a part number generator of the specification generating module 10, the part number generator compiles subordinated part numbers in a hierarchical manner based on the subordinate relationships of the elements 12. For instance, one of the elements 12 being a button, a key, may be executed for compiling the elements 12 and the corresponding part numbers according to the inputted parameter types, the logic operation element, the output field, etc. For instance, the part number of one of the elements 12 being a “send” button is set as 10000, in which the “send” button is to read the value of another element 12 being a “input parameter” (part number 10100) and another element 12 being a “string” (part number 10200); another element 12 being an “output drawing” (part number 10310) may be used to generate and output a drawing, in which the “output drawing” element 12 uses a coordinate axis conversion element (part number 10310) and a color block generating element (part number 10320) to output that drawing. As a result, each of the elements 12 used may have a hierarchical relationship with a non-repetitive part number. The compilation and relationships of the part number are not limited to the foregoing example. For another instance, in order to confirm that the elements 12 corresponds to the upper and lower order of the part numbers, the attributes of the elements 12 may be defined or marked with the upper order element 12, so that the subordinate relationships of the elements 12 and part numbers can be generated, so as to generate the structured specification.

The software system generating module 20 executes the following steps for generating the result system B:

Specification importation: to import or input structured specification by the specification generating module 10.

Coding: The system generation module 20 analyzes the system architecture, generates a form, a database, and a user interface layout based on the characteristics of all the elements 12 in the structured specification. In which the software system generating module 20 generates a system menu and its relevant links based on the analyzed system architecture; generates a database schema based on the database content; establishes the data processing requirements for each of the defined forms according to each defined element 12. Using internally stored and pre-defined program corresponding to the elements 12 to form a complete processing procedure, including commands of the database. For instance, the coding procedure is to define attributes, operative logics, input-out relationships, value relationships, etc. of each of the elements 12 based on the structured specification, and the program segments between the elements 12 are combined according to the defined order to generate a system program code combination.

Compiling procedure: The software system generating module 20 compiles and interprets the system program code combination to generate the result system B.

In conclusion, the advantages using the present invention are listed below:

1. All communications between the clients making requirements and the system/program designers are completed, during setting and generating the structured specification, therefore, after confirming the structured specification, it would be confirmed that the results output from system execution meets the requirements as specified in the structured specification. If the executed result of the program to be developed does not meet the original requirements or encounters errors, it leads to the structured specification rather than the programming itself. Hence, the automatic software program generating system disclosed in the present invention may solve problems of missing information or misunderstandings majorly caused while generating programmer-understandable workflow and descriptions by the clients and the system analysts, and the back-and-forth communications among multiple teams of multiple programmers interpreting the workflow and descriptions to divide the programming works for building the corresponding program modules, which lead to significant prolongation of development time and cost increment of development.

2. After completion of the structured specification, the clients, users, may deliver the entire BOM to a program (software) factory for automatic processing, and obtain a final product that is the system application that should meet the structured specification of a specific project for the client's final inspection and confirmation. The programs implemented in the so-called program factory is adapted to read the BOM content of the specific project, correctly and entirely interpreting the programming details of system designers in order to automatically generate an executable system application according to the BOM content without involving any man programmers, thereby saving a lot of manpower resources and time and controlling the due date and the quality of their product produced.

The description of the invention including its applications and advantages as set forth herein is illustrative and is not intended to limit the scope of the invention, which is set forth in the claims. Variations and modifications of the embodiments disclosed herein are possible, and practical alternatives to and equivalents of the various elements of the embodiments would be understood to those of ordinary skill in the art upon study of this patent document. For example, specific values given herein are illustrative unless identified as being otherwise, and may be varied as a matter of design consideration. Terms such as “target” and “background” or so are distinguishing terms and are not to be construed to imply an order or a specific part of the whole. These and other variations and modifications of the embodiments disclosed herein, including of the alternatives and equivalents of the various elements of the embodiments, may be made without departing from the scope and spirit of the invention, including the invention as set forth in the following claims

What is claimed is:

1. A software system generating system comprising a specification generating module and a software system generating module, wherein:
the software system generating module outputs a structured specification according to information being provided by user's demand;
the software system generating module includes a plurality of predefined elements which each element is a programmable unit;
the structured specification defines characteristics of the element to generate forms which the characteristic is a combination relationship of the plurality of predefined elements;
the structured specification defines a relationship of each element in the form and the structured specification defines a relationship and a subordinate relationship of two forms;
after inputting the structured specification into the software system generating module and processing through a coding process, the system module analyzes the system architecture, generates the form, a database, and a user interface layout based on the characteristics of the elements in the structured specification;
the software system generating module generates a system menu and its relevant links based on the analyzed system architecture;
generates a database schema based on the database content;
using internally stored and predefined program corresponding to the element to form a complete processing procedure; and
the software system generating module complies and interprets the system program code combination to generate the result system.

2. The software system generating system as claimed in claim 1, wherein format of the structured specification is extensible markup language (XML).

3. The software system generating system as claimed in claim 1, wherein
the structured specification is a bill of material (BOM) format;
each element has a non-repetitive part number; and
the non-repetitive part number is generated by a part number generator.

4. The software system generating system as claimed in claim 1, wherein the characteristics of the element includes an arithmetic logic, a logic relationship, a text, a value, a range of values, an attribute, input-output interaction relationship or a subordinate relationship.

5. The software system generating system as claimed in claim 4, wherein the attribute of the element includes defining a subordinate relationship of corresponding part number.
